(19) United States
(12) Patent Application Publication
(10) Pub. No.: US 2006/0060802 A1
(43) Pub. Date: Mar. 23, 2006

(54) Arrangement for generating fingerprints for optoelectronic image recording

(75) Inventors: Uwe Richter, Jena (DE); Roland Bornheim, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Smiths Heimann Biometrics GmbH

(21) Appl. No.: 11/159,011

(22) Filed: Jun. 22, 2005

(30) Foreign Application Priority Data
Jun. 25, 2004 (DE) 10 2004 032 000.4

(51) Int. Cl. G06K 11/00; G06K 9/00

(52) U.S. Cl. 250/556; 382/124

(57) ABSTRACT

The invention is directed to an arrangement for generating fingerprints for an optoelectronic image recording which has a prism for illuminating and imaging fingerprints of at least one finger that is placed on a support surface of the prism. At least one heating element is provided for preventing condensation effects occurring at the support surface. The object of the invention is to find a novel possibility for generating fingerprints for the optoelectronic recording of the fingers of a hand which enables an efficient heating of the support surface without requiring long warm-up phases when putting into operation and which, at the same time, is robust and not sensitive to mechanical and chemical stresses. This object is met, according to the invention, in that the prism at the support surface is provided with an optically active plane-parallel cover layer comprising a hard optical material with good heat conductivity. The cover layer is applied by an optical connecting layer with adapted refractive index and thermal expansion coefficient, and a heating element has a planar heat-conducting connection to the edge of the cover layer.

### CROSS-REFERENCE TO RELATED APPLICATION

This application claims priority of German Application No. 10 2004 032 000.4, filed Jun. 25, 2004, the complete disclosure of which is hereby incorporated by reference.

### BACKGROUND OF THE INVENTION

a) Field of the Invention

The invention is directed to an arrangement for generating fingerprints for an optoelectronic image recording which has a prism for illuminating and imaging fingerprints of at least one finger that is placed on a support surface of the prism, wherein at least one heating element is provided for preventing condensation effects occurring at the support surface. The invention is applied in devices for personal identification based on the checking of biometric features, particularly for border controls, visa applications, and visa checks.

b) Description of Aspects of the Inventive Discovery and Related Prior Art

As biometric features are increasingly used for routine personal identification, the requirements for the robustness of the technical equipment needed for this purpose become more demanding.

Scanners which detect the pattern of papillary lines and convert it into digital information immediately and directly, i.e., without the use of conventional aids such as ink and paper, simply by placing the finger on a flat support surface are already in use for the detection of fingerprints.

This affects a very large number of people, especially for applications in the areas of border control, visa checking and civilian background checking, and the number of persons registered in these systems can very quickly reach many millions.

In order to identify a person, i.e., to determine when searching a database based on the presently detected fingerprints of this person whether or not the person is already contained in the database, special steps must be taken in such large databases so that the automated search accesses the required area. In this connection, it has proven advantageous to use as many fingerprints of a person as possible, e.g., of all ten fingers. Because of the considerable time required to place all ten fingers successively on a (small-surface) scanner, simultaneous recording of all of the fingers on a hand is increasingly preferred. The scanners required for this purpose are exposed to great stresses when in permanent use, i.e., when fingerprints of different persons are recorded within an interval of a few minutes, e.g., in a consulate for processing visa applications or at border control points for authentication and for comparing the presently acquired fingerprints with the visa.

Devices of the type mentioned above must achieve a consistently high quality of the acquired fingerprints which must not deteriorate during use and which must also remain stable under changing environmental conditions such as fluctuations in temperature and air humidity at the place of use.

A known problem is caused by condensation processes which occur when a relatively moist finger (of a perspiring person) is placed on a cold prism. The condensation on the prism may possibly be visible as a dark area in the fingerprint image and can cause errors in the image of the papillary lines.

In order to prevent condensation effects on the support surface, it has long been known to preheat the finger support surface in prisms to a determined temperature by means of heating elements arranged at the end sides.

Further, this step contributes to an improvement in the quality of the fingerprints because warm, soft skin results in better fingerprints than cold, hard skin due to the fact that the heated epidermis is more resilient and when the fingers are dry the skin is stimulated to secrete small quantities of perspiration.

Fingerprint scanners that can acquire an individual fingerprint are known generally from the field of access control. Such scanners are available in a wide variety of constructions and operate with optical, capacitive, resistive, pressure sensitive or ultrasound methods.

Scanners based on the principle of frustrated total reflection have become popular for simultaneous recording of the fingerprints of a plurality of fingers or of an entire hand because the recording times can be kept very short. For recording, e.g., all four elongated fingers of one hand, the support surface, which is usually arranged horizontally in front of the user, has a width of 80 mm and a depth of 65 mm, for example, and is accordingly substantially larger than any fingerprint sensor based on a semiconductor chip. With such dimensions of the support surface, an additional technical problem is posed by maintaining readiness for continuous operation.

US 2003/0142856 A1 describes an arrangement based on the known principle of frustrated total reflection with a prism for a fingerprint scanner for simultaneous detection of four fingers of a hand which are placed flat. In a preferred constructional variant, the prism is provided with an additional layer of silicone rubber to improve the fingerprint quality of dry fingers. Because of the known disadvantage that these layers gradually deteriorate with respect to their optical characteristics due to the influence of hand perspiration and, moreover, are very sensitive to scratching and any type of mechanical or chemical loading, the silicone layer is described as exchangeable so that the layer, when worn, may be replaced with a new layer in a simple manner at any time.

However, the silicone layer has the additional disadvantage that it acts in a thermally insulating manner and increasingly so as the thickness increases. For purposes of mechanical stability, it would be advantageous for the layer to be as thick as possible, but due to the thermal insulation this would be disadvantageous since the heat from the heated prism could not reach the finger support surface quickly enough to prevent condensation.

But even without a silicone layer, there are sufficiently severe problems with scratching and wear because the prism is generally made from optical glass or optical plastic. Scratches on the support surface of the prism are visible as disturbances in the image of the finger and impede identification of the fingerprints. In severely scratched prisms, substantial portions of the fingerprint can even be hidden so that identification can no longer be carried out automatically or can no longer be carried out in the required short processing times per person.

In order to prevent condensation effects on the support surface of a prism, U.S. Pat. No. 5,825,474, for example, describes the use of heat radiation in a cover plate covering the support surface. However, this requires that this cover plate lies on the prism for most of the time and is removed temporarily only during use. If this cannot be guaranteed, which is the case, for example, in a user-operated system (without specially trained personnel), this heating does not function reliably because the user may forget to replace the cover plate on the prism after use.

U.S. Pat. No. 5,249,370 describes another solution in which heated air is blown over the recording surface. In practical application, this has the disadvantage that the air flow must be relatively hot and powerful in order to exercise a sufficiently effective heating function and a hot, powerful air flow of this kind causes an unpleasant sensation on the hand.

Fingerprint scanners with direct prism heating for heating the finger support surface have been marketed since 1999 (Heimann Biometric Systems GmbH, Germany). These fingerprint scanners have heating elements arranged at both end faces of the prism (parallel bottom and top surfaces) and couple the heat into the prism by means of materials with good heat conductivity. However, this solution, although robust in itself, has the disadvantage that immediately after the device is switched on a relatively long period of time elapses before the support surface has achieved a homogeneous, optimal temperature. This is due to the relatively poor heat conduction of the prism which results during the warm-up phase in an appreciable drop in temperature between the center of the support surface, which is still cold, and the end faces which are already warm. The warm-up process depends upon the size of the prism, the current ambient temperature, and the heat output that is coupled in. The preliminary heating period typically ranges from several minutes to an hour. However, faster heating through increased heating output is subject to strict limits since otherwise thermal stress states occur within the prism.

### OBJECT AND SUMMARY OF THE INVENTION

It is the primary object of the invention to find a novel possibility for generating fingerprints for the optoelectronic image recording of the fingerprints of a human hand which enables an efficient heating of the support surface without waiting for long warm-up phases when putting into operation and which, at the same time, is robust and not sensitive to mechanical and chemical stresses.

In the arrangement for generating fingerprints for an optoelectronic image recording which has a prism for illumination and imaging of fingerprints of at least one finger that is placed on a support surface of the prism, wherein at least one heating element is provided for preventing condensation effects occurring at the support surface, the above-stated object is met, according to the invention, in that the prism at the support surface is provided with an optically active plane-parallel cover layer comprising a hard optical material with good heat conductivity, in that the cover layer and the prism are combined by means of an optical connecting layer to form an optical composite body, wherein the connecting layer has a refractive index and thermal expansion coefficient that are adapted to the prism and cover layer, and in that the heating element has a planar heat-conducting connection to the edge of the cover layer.

The cover layer advantageously comprises a mineral glass or organic glass. A sapphire (possibly also curved) plate is advantageously used as mineral cover layer. Polymer plastics with a high transparency and relatively good heat conductivity, preferably CR39, which are additionally surface-hardened by coating are advisably used as organic glass.

The cover layer is advisably glued to the prism by optical cement in order to produce a defined optical composite body of the prism and cover layer. The cement is an optical adhesive with high transparency and high flexibility and is advantageously a photopolymer adhesive, particularly a UV-curable adhesive.

However, the cover layer and the prism can also be connected by an optical immersion liquid, in which case the immersion liquid and the cover layer are advisably mounted in a clamping frame that is mechanically joined to the prism in order to produce a mechanically rigid composite and to prevent evaporation of the immersion liquid.

In order to suppress condensation effects at the cover layer, heating elements are advisably provided with a heat distributor for coupling heat into the cover layer over a large surface. The heat distributor advisably comprises a very good heat conductor, particularly copper, and communicates with the cover layer by heat-conducting matting or heat-conducting paste.

In an advantageous design of the heat distributor, a plurality of heating elements, each with a heating bar for coupling in heat, are connected to at least two edge areas of the cover layer. The heating bars are advisably arranged on at least two opposite edge areas of the cover layer.

In another variant for heat distribution, a heating element is connected to at least two edge areas (border areas) of the cover layer by a heating frame for coupling in heat.

A particularly advantageous construction has a U-shaped heating frame, the support surface for the fingers being enclosed on three sides by the heating frame. The heating frame is advisably arranged in the edge area on the support surface of the cover layer.

If the U-shaped heating frame were to be defined as a base area with two legs, the active heat source would preferably be arranged in the base area of the heating frame. In an advantageous manner, temperature sensors and display elements which display the operating states and/or the success or failure of the recording of the fingerprints can also be arranged in this base area. The display elements are preferably constructed as light-emitting diodes provided with pictograms. The temperature sensor can also advisably be arranged on at least one leg of the heating frame.

The invention is based on the fundamental consideration that wear on the prism surface caused by scratches poses a considerable problem for quality assurance of the fingerprint recordings in large-surface fingerprint scanners based on the principle of frustrated total reflection that are in constant use (e.g., at border control points, in consulates, etc.). Any protective layers or hardened surfaces of the prism degrade the optical recording or impede the conventional heating of the prism for preventing condensation which, in any case, has the disadvantage of very long heating times.

The invention solves this dilemma in that a thin, plane-parallel cover layer of hard mineral glass or organic glass is arranged on the optical support surface for the fingerprint (typically a prism of BKT-type glass).

In every case, the optical composite body comprising the prism and cover layer, which is preferably formed by optical cements, has transitions (prism glass to cement to cover layer, and vice versa) which are optically active for the principle of frustrated total reflection, but can be calculated without difficulty—as in optic design for lens systems—and requires substantially less energy for heating the support surface compared to conventional solutions (in which the entire prism is heated) because only the thin cover layer (with a low heat capacity) must be heated. Further, the sapphire (currently the hardest optically usable material) which is preferably used as cover layer has the advantageous characteristic, compared to prism glass (BK7), that it conducts heat particularly well (×28 heat conductivity).

With the solution according to the invention, it is possible to generate fingerprints of a plurality of fingers of a hand with a quality suitable for optoelectronic image recording. The arrangement permits an efficient heating of the support surface without long warm-up phases when putting it into operation (or after standby mode) and without having to expend considerable amounts of energy for continuous temperature control of the support surface and, at the same time, is robust and not sensitive to mechanical and chemical loading. In the preferred construction with a sapphire cover layer, excellent heat conductivity is also achieved in addition to a high resistance to scratching.

The invention will be described more fully in the following with reference to embodiment examples.

### BRIEF DESCRIPTION OF THE DRAWINGS

In the drawings:

FIG. 1 shows a schematic view of the arrangement according to the invention as a section through the optical composite body;

FIG. 2 shows a front view of a construction with immersion liquid and a clamping frame and with heating elements at opposite edge areas of the cover layer;

FIG. 3 shows a perspective view of an embodiment form with a heating element in the form of a U-shaped heating frame;

FIG. 4 shows a construction according to FIG. 3 in a top view of the support surface with the fingers of a hand placed on it and a heating frame with display elements; and

FIG. 5 shows a side view of the construction analogous to FIG. 4, but with a curved prism surface and adapted cover layer and a heating frame with connections.

### DESCRIPTION OF THE PREFERRED EMBODIMENTS

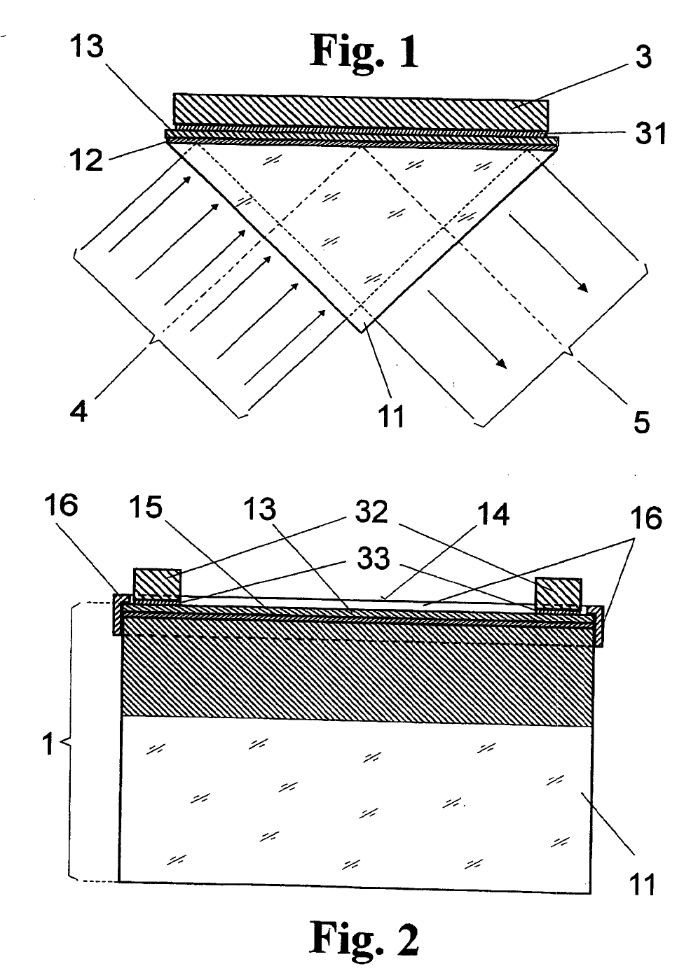

FIG. 1 shows a basic construction of the invention as a sectional drawing of an optical composite body 1 comprising a prism 11 and a plane-parallel cover layer 13 which is joined by means of a connecting layer 12. Depending upon the material and upon the manner in which the prism 11 is fastened, the cover layer 13 has a relatively small thickness (approximately 0.5 mm to 5 mm).

The free surface of the cover layer 13 is the support surface 14 for placement of the fingers 2 and is provided in its edge area, above heat-conducting matting 31, with a heating element 3 and accordingly, at the same time, serves as the heat input surface for the cover layer 13 (for suppressing condensation effects at the support surface 14 when the finger 2 is placed on the latter). The heat can be generated by electric heaters based on resistors, heating transistors or other electronic components. The heat is introduced from the heating element 3 to the cover layer 13 by heat conduction, e.g., by means of heat-conducting materials of metal (copper) or plastics (heat-conducting matting, elastic plastics with metal particles) or by a thin, durable flexible adhesive layer with good heat conductivity.

Further, the prism 11 has an illumination surface for coupling in the illumination light 4 and a readout surface for the imaging beam path 5 so that fingerprints can be recorded based on the principle of frustrated total reflection.

The cover layer 13 is thermally separated from the optical prism 11 by the connecting layer 12 which is preferably a highly transparent, flexible optical glue, so that it is possible to heat the support surface 14 for the fingers 2 exclusively by means of the cover layer 13. The advantage consists in simple heating. Since the cover layer 13 is very thin, a comparatively low heat output is sufficient for managing the temperature of the support surface 14. This is advantageous for the design of the power supply of a fingerprint scanner. A further advantage consists in that every time a device for recording fingerprints is restarted, the support surface 14 has already reached its operating temperature within a short period after switching on.

The cover layer 13 is made of a material having a high transparency, maximum scratch resistance, as well as good resistance to chemicals so that the optical composite body 1 has a long operating life even when used constantly and in a careless fashion, and preferably comprises sapphire.

A fingerprint scanner that is outfitted with a composite body 1 of the kind described above, particularly using a cover layer 13 of sapphire, is also highly stable relative to mechanical and chemical stresses which occur due to continuous contact with fingers. In this case, even unconscious or unintentional scratching by fingernails, rings or keys does not lead to problems. Aside from the plane-parallel plate shape that is preferably used, the cover layer 13 can also be a curved surface layer (e.g., a cylindrical outer surface, see FIG. 5) which can also easily be produced from sapphire or organic glass.

The embodiment form in FIG. 2 shows a front view of the prism 11 with an immersion liquid 15 as connecting layer to the cover layer 13. In this front view, the composite body 1 is seen in section and the edges of the prism 11 and of the cover layer 13 are framed by a clamping frame 16 extending around the periphery. Accordingly, if necessary, the cover layer 13 can be exchanged independent from the prism 11. This is useful especially when an organic glass which—even when coated or surface-hardened—does not achieve the mechanical and chemical resistance of sapphire is used as cover layer 13. Polymer plastic glasses, e.g., CR 39 (Columbia Resin 39), preferably with coating for surface hardening (increased scratch resistance as is conventional in plastic eyeglasses) can be used as organic glass.

Further, FIG. 2 shows a design variant of the invention with two separate heating bars 32 which are arranged, respectively, at opposite lateral edges in the edge area of the cover layer 13. The edge area of the support surface 14 is used over a relatively large surface in order to have a sufficient contact surface for the transfer of heat to the cover layer 13 via a heat-conducting adhesive 33 because of the small thickness of the cover layer 13 (approximately 0.5 mm to 5 mm).

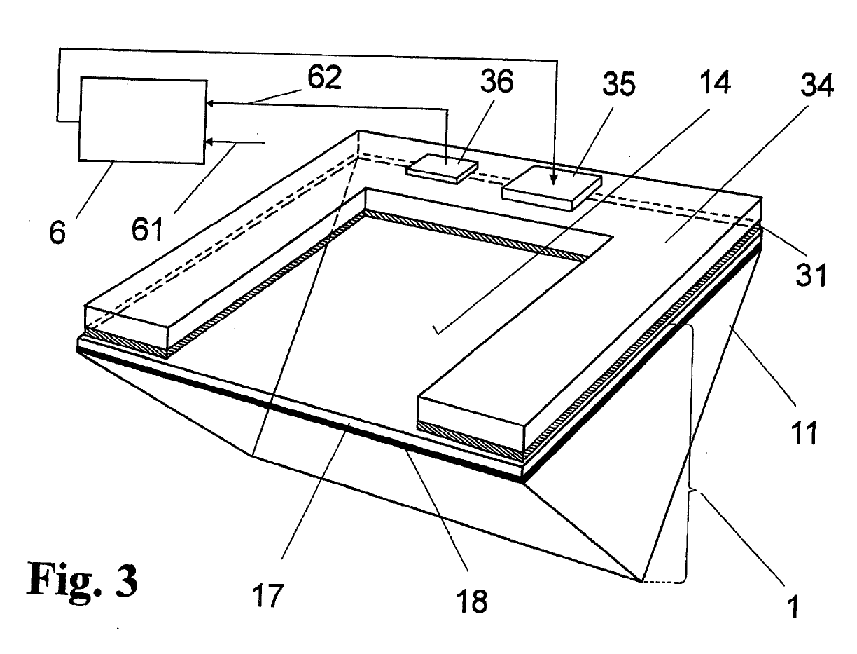

FIG. 3 shows an advantageous embodiment of the arrangement according to the invention in a perspective view.

In this example, the heating element 3 is constructed in such a way that it forms a heating frame 34 in the form of an inverted U. The heating frame 34 is arranged along three side edges on the recording surface 14 of the composite body 1 above heat-conducting matting 31 (or, alternatively, above a heat-conducting, flexible glue).

A heating transistor 35 and a temperature sensor 36 are arranged in thermal contact in the base area of the heating frame 34 which is located behind the support surface 13 from the perspective of the person whose finger 2 is placed thereon.

The heating transistor 35 and temperature sensor 36 are connected by electrical connections to a heat regulator 6 which compares the given reference temperature signal 61 (equivalent to 35° C., for example) to the actually measured temperature signal 62 and forms the heat control signal 63 therefrom by which the heating transistor 35 is switched on or off.

After an initial warm-up phase, the temperature of the sapphire plate 17 arranged on the prism 11 is maintained at a desired value in this way. The mechanical and optical composite body 1 comprising the prism 11 and the sapphire plate 17 is produced so as to be permanently fixed by means of an optical cement 18.

The heating transistor 35 delivers its heat to the heating frame 34 which conducts this heat over its volume and transmits it by its surface to the three edge areas of the sapphire plate 17 lying under it.

The heating frame 34 comprises a material with good heat conductivity (e.g., copper) and its surface can be painted without impairing function. The transfer of heat from the heating frame 34 to the sapphire plate 17 (or to any other suitable cover layer 13) is carried out by means of thin heat-conducting matting 31 which has good heat conductivity and exactly the same contour as the contact surface of the heating frame 34. The heat-conducting material 31 transfers the heat to the sapphire plate 17 which is located under it and which extends over the entire surface of the prism 11.

The use of the sapphire plate 17 as cover layer 13 imposes strict requirements with respect to optical characteristics on the cement 18 as concrete construction of the connecting layer 12 (FIG. 1); but these requirements can be met with the resolutions typical for the application and the demands with respect to freedom from defects (bubbles, striae). Further, the cement 18 must absorb thermal stresses which occur as a result of the increased thermal expansion of the heated sapphire plate 17 relative to the colder prism 11. A highly transparent, highly elastic photopolymer glue, particularly a UV-curing photopolymer (e.g., NOA 61 by Norland Products Inc., USA) is preferably used as optical cement 18 which can also be processed easily.

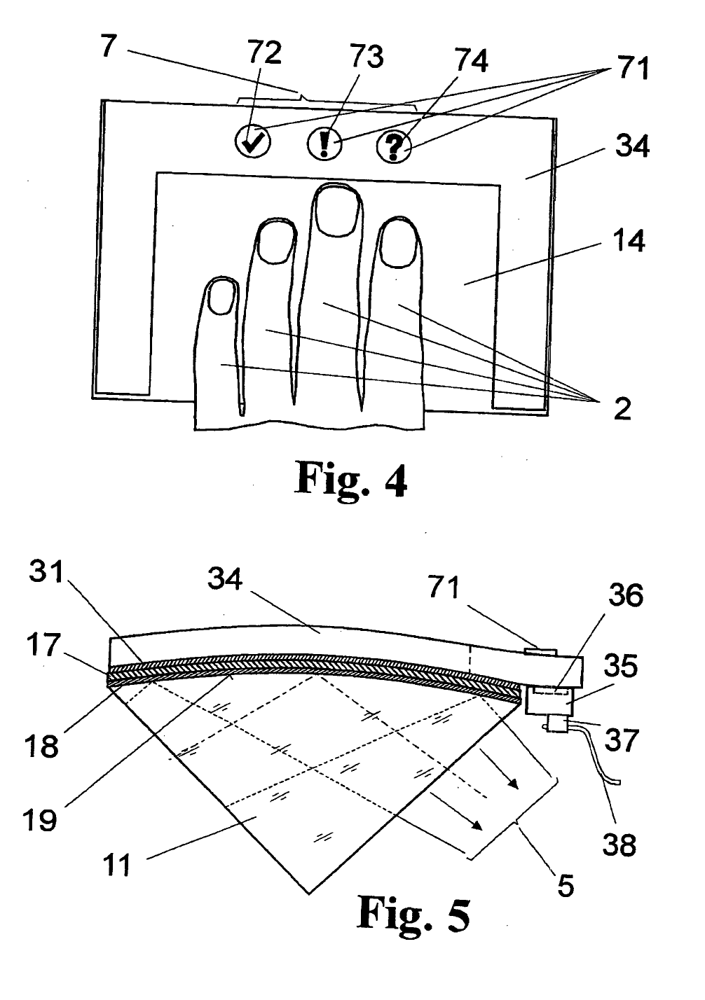

FIG. 4 shows a top view of the arrangement in FIG. 3. Four fingers 2 of a person lie flat on the support surface 14. The part of the support surface 14 that is freely accessible, i.e., is not covered by the U-shaped heating frame 34, is selected in such a way that it corresponds to the conventional format for the area on a fingerprint card reserved for receiving fingerprints. Accordingly, four fingers 2 easily fit on the free area of the support surface 14 and the acquired images with the fingerprints correspond in size to the usual standards in the field of electronic fingerprint transfer as used internationally (Interpol, FBI). The subject is instructed to keep his/her fingers 2 extended and then to move them as far as possible from the rear until almost to the base area of the heating frame 34 before placing the fingers 2 flat upon the recording surface 14. This process is easily understandable and can also be comprehended intuitively due to the raised construction of the heat frame 34.

Additional display elements 7 are arranged in the base area of the U-shaped heating frame 34. They are used for interaction between the person and the device (not shown) and are constructed, for example, as LEDs 71 with pictograms 72 to 74 for displaying important operating states of the device (fingerprint scanner). For this purpose, the device can be designed in such a way that the image of the support surface 14 serving as recording surface (object plane) for an image sensor (not shown) which is optically read out by the imaging beam path 5 is converted by the image sensor into a digital image and periodically evaluated by a calculating unit and checked for the presence or absence of fingerprints.

As soon as a finger 2 is detected, whose quality in the digital image achieves a minimum quality (with respect to surface, contrast, quantity of minutiae contained in the fingerprint, etc.), the acquired image is categorized either as good (storable) or as bad (and therefore not usable) and an LED 71 associated with one of these categories is switched on.

Therefore, the user receives a direct acknowledgment either that his/her fingerprints were correctly detected (LED 71 with pictogram 72) or that they were assessed as “bad” (LED 71 with pictogram 74) and that the process must be repeated.

If the determined quality lies between the quality criteria considered as definitely good and as definitely bad, an LED 71 with pictogram 73 can be switched on. This alerts the user that the recorded fingerprint may still possibly be usable. The user will then decide whether to use or reject this fingerprint image after visual inspection.

FIG. 5 shows further details of the heating element 3 in a side view. In its base area (shown at right in this view), the heating frame 34 is constructed in such a way that it has sufficient space to allow the heating transistor 35 and the display elements 7 to be mounted so as to be directed downward. Accordingly, there is a smooth surface on top, while the elements necessary for determining function, i.e., the heating transistor 35, temperature sensor 36, plug-in connector 37 and connection cable 38, are hidden from view and protected in the interior of the device. In this connection, it must be ensured that there is no conflict between the optical display elements LED 71 and the optical imaging beam path 5.

For purposes of simple assembly, all of the electrical connections between the elements mounted at the heating frame 34, i.e., the heating transistor 35 and LEDs 71, and the control electronics of the device (including the heat regulator 6), are guided via a flat plug-in connector 37 and connection cable 38.

In this case, the optical composite body 1 comprises a specially shaped prism 11 with a (e.g., cylindrically) curved surface 19, which is better adapted to the shape of the hand, and a correspondingly curved cover surface 13 which is glued on with optical cement 18. Therefore, the composite body 1 with the addition of the heating element 3 comprising heating frame 32, heating transistor 35, temperature sensor 36 and display LEDs 71 can be preassembled as a separate subassembly and installed in a simple manner in the prepared device for recording fingerprints based on frustrated total reflection. Aside from the optical alignment of the optical surfaces for the illumination light 4 and imaging beam path 5, it is only necessary to connect the connection cable 38 via the plug-in connector 37 for the heating element 3 and the display elements 7.

It will be clear to the person skilled in the art that the invention can also be realized as combinations of the constructions of various embodiment examples described herein. Accordingly, it is also comprehended within the teaching of the invention that the heating frame can also enclose the support surface 14 on all four sides or that, instead of a uniform heating element 3, it can comprise a plurality of separate heating elements (heating bars 32) which contact one or two opposite pairs of sides or adjacent sides of the support surface 14.

Further, the heating frame 34 can also project out over the side edges of the prism 11 and can accordingly be constructed at the same time as a fastening frame of the heating element and of the optical composite body 1 in the fingerprint scanner. In this case, thermally insulating layers are provided for the housing so that no heat is conducted into the housing parts.

Further, semitransparent structures in the form of test structures for verifying the correct recording of fingerprints and for maintaining quality parameters, e.g., optical resolution (MTF) or geometric accuracy (absence of distortion), can be applied before arranging the cover layer 13 (or sapphire plate 17) on the prism and are protected against wear by the terminating cover layer 13. A suitable procedure for quality inspection is described, for example, in DE 199 27 025 and U.S. Pat. No. 6,407,804 (Hillman et al.).

Instead of a prism 11 using the principle of frustrated total reflection, a glass plate with a cover layer 13 using other optical principles (e.g., scattered light) can also be provided without departing from the framework of the present invention.

While the foregoing description and drawings represent the present invention, it will be obvious to those skilled in the art that various changes may be made therein without departing from the true spirit and scope of the present invention.

### REFERENCE NUMBERS

1 composite body
11 prism
12 connecting layer
13 cover layer
14 support surface
15 immersion liquid
16 clamping frame
17 sapphire plate
18 optical cement
19 curved surface
2 finger
3 heating element
31 heat-conducting matting
32 heating bar
33 heat-conducting glue
34 heating frame
35 heating transistor
36 temperature sensor
37 plug-in connector
38 connection cable
4 illumination light
5 imaging beam path
6 heating regulator
61 reference temperature signal
62 actual temperature signal
63 heat control signal
7 display elements
71 LED
72-74 pictograms

What is claimed is:

1. An arrangement for generating fingerprints for an optoelectronic image recording comprising:
a prism for illuminating and imaging fingerprints of at least one finger that is placed on a support surface of the prism;
at least one heating element being provided for preventing condensation effects occurring at the support surface;
the prism at said support surface being provided with an optically active plane-parallel cover layer comprising a hard optical material with good heat conductivity;
said cover layer and said prism being combined by an optical connecting layer to form an optical composite body;
said connecting layer having a refractive index and thermal expansion coefficient that are adapted to the prism and cover layer; and
said heating element having a planar heat-conducting connection to the edge of the cover layer.

2. The arrangement according to claim 1, wherein the cover layer comprises a mineral glass.

3. The arrangement according to claim 2, wherein the cover layer is a sapphire plate.

4. The arrangement according to claim 1, wherein the cover layer is an organic glass.

5. The arrangement according to claim 4, wherein the cover layer comprises a polymer plastic.

6. The arrangement according to claim 5, wherein said polymer plastic is CR39.

7. The arrangement according to claim 4, wherein the cover layer is surface-hardened by coating.

8. The arrangement according to claim 1, wherein the cover layer is glued to the prism by optical cement.

9. The arrangement according to claim 8, wherein the cement is an optical adhesive with high transparency and high flexibility.

10. The arrangement according to claim 9, wherein the cement is a photopolymer adhesive.

11. The arrangement according to claim 10, wherein said photopolymer adhesive is a UV curable adhesive.

12. The arrangement according to claim 1, wherein the cover layer and the prism are connected by an optical immersion liquid, wherein the immersion liquid and the cover layer are mounted in a mechanical clamping frame at the prism.

13. The arrangement according to claim 1, wherein the heating element has a heating transistor as active heat source.

14. The arrangement according to claim 1, wherein the heating element has a heat distributor for coupling heat into the cover layer over a large surface.

15. The arrangement according to claim 14, wherein the heat distributor comprises a very good heat conductor.

16. The arrangement according to claim 15, wherein the heat conductor is copper.

17. The arrangement according to claim 14, wherein the heat distributor communicates with the cover layer by heat-conducting matting.

18. The arrangement according to claim 14, wherein the heat distributor communicates with the cover layer by a heat-conducting glue.

19. The arrangement according to claim 14, wherein heating elements, each with a heating bar for coupling in heat, are connected to at least two edge areas of the cover layer.

20. The arrangement according to claim 19, wherein the heating bars are arranged on at least two opposite edge areas of the cover layer.

21. The arrangement according to claim 14, wherein the heating element has a heating frame at at least two edge areas of the cover layer for coupling in heat.

22. The arrangement according to claim 21, wherein the heating frame is constructed in a U-shaped manner, wherein the support surface for the fingers is enclosed on three sides by the heating frame.

23. The arrangement according to claim 22, wherein the U-shaped heating frame is arranged in the edge area on the support surface of the cover layer.

24. The arrangement according to claim 22, wherein the heating frame has a base area and two legs, wherein the active heat source is arranged in the base area.

25. The arrangement according to claim 24, wherein the heating frame has a temperature sensor in the base area.

26. The arrangement according to claim 24, wherein the heating frame has a temperature sensor at at least one leg.

27. The arrangement according to claim 24, wherein display elements which display the operating states or the success or failure of the recording of the fingerprints are arranged in the base area of the heating frame.

28. The arrangement according to claim 27, wherein the display elements are light-emitting diodes provided with pictograms.
